(19) United States
(12) Patent Application Publication
(10) Pub. No.: US 2006/0002057 A1
(43) Pub. Date: Jan. 5, 2006

(54) Socket for a CPU with land grid array

(75) Inventor: Huang-Chou Huang, Taipei (TW)

Correspondence Address: Dennison, Schultz & Dougherty & Macdonald, Suite 105, 1727 King Street, Alexandria, VA, 22314, US

(73) Assignees: SUYIN CORPORATION; CHUPOND PRECISION CO., LTD.

(21) Appl. No.: 10/879,352

(22) Filed: Jun. 30, 2004

(51) Int. Cl. G06F 1/16

(52) U.S. Cl. 361/679

(57) ABSTRACT

A socket for a CPU with L.G.A includes a bottom plate and a frame. Multiple apertures are defined through the bottom plate. Multiple metal strips are respectively secured in the apertures by fasteners. Each metal strip has two deformable free ends extending upwards and downwards out from the respective aperture. Multiple supporting members are respectively formed on inner walls of the apertures and opposite to the metal strip for abutting the deformable free ends when the metal strips are pressed. The frame is securely mounted on the bottom plate and has an opening corresponding to the apertures. Edges are formed around the opening for clamping the CPU. Notches are defined at corners between the edges.

### BACKGROUND OF THE INVENTION

1. Field of the Invention

The present invention relates to a CPU socket, and more particularly to a socket which ensures a CPU with a Land Grid Array can reliably connect with nodes on a mainboard.

2. Description of Related Art

CPUs have three types of terminals electrically connected with circuits on a mainboard, including P.G.A (Pin Grid Array), B.G.A (Ball Grid Array), and L.G.A (L.G.A.).

The P.G.A type CPU has pin-like terminals with a great length, so a socket for this type CPU must have a great thickness corresponding to the P.G.A terminals. A conventional socket for the P.G.A CPU is issued as disclosed in U.S. Pat. No. 5,456,613.

For miniaturizing the CPU, the B.G.A type CPU was invented with ball-like terminals such as tin balls or copper balls. A conventional socket for the B.G.A CPU is issued as disclosed in U.S. Pat. No. 5,419,710.

For further miniaturizing the CPU, the L.G.A CPU has been developed with simple structure, low cost, and good electrical connection. The L.G.A CPU has flat land-like terminals. Conventional sockets adapted to this L.G.A CPU are issued as disclosed in U.S. Pat. Nos. 5,192,213; 5,199,889, 5,232,372, 5,320,559, 5,362,241, and 5,389,819.

For reducing an area of a CPU, two adjacent terminals of the CPU have a very small clearance therebetween. Thus, apertures of the socket for receiving the terminals have a high density. The apertures each have a metal strip for being electrically connected with the respective terminals and a circuit on a mainboard. For providing a reliable electrical connection, the metal strips have a deformable part with a certain elasticity. However, limited by the thickness of the socket, the conventional metal strips have a complex structure with an insufficient elasticity. Moreover, when continuously pressed by the terminals for a long time, elastic fatigue may appear in these metal strips, and electrical connection between the CPU and the circuit becomes unreliable.

Therefore, the invention provides a CPU socket to mitigate or obviate the aforementioned problems.

### SUMMARY OF THE INVENTION

The main objective of the present invention is to provide a CPU socket which can eliminate elastic fatigue of metal strips to ensure that a CPU is reliably and electrically connected with a circuit board.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a socket for a CPU in accordance with the present invention;

FIG. 2 is a perspective view of the socket in FIG. 1;

FIG. 3 is a partially sectional view showing that a CPU being installed in the socket assembled on a mainboard;

FIG. 4 is a partially sectional view showing that the CPU has been installed in the socket;

FIG. 5 is an exploded perspective view of a second embodiment of the socket in accordance with the present invention; and

FIG. 6 is an exploded perspective view of a third embodiment of the socket in accordance with the present invention.

### DETAILED DESCRIPTION OF THE PREFERRED EMBODIMENT

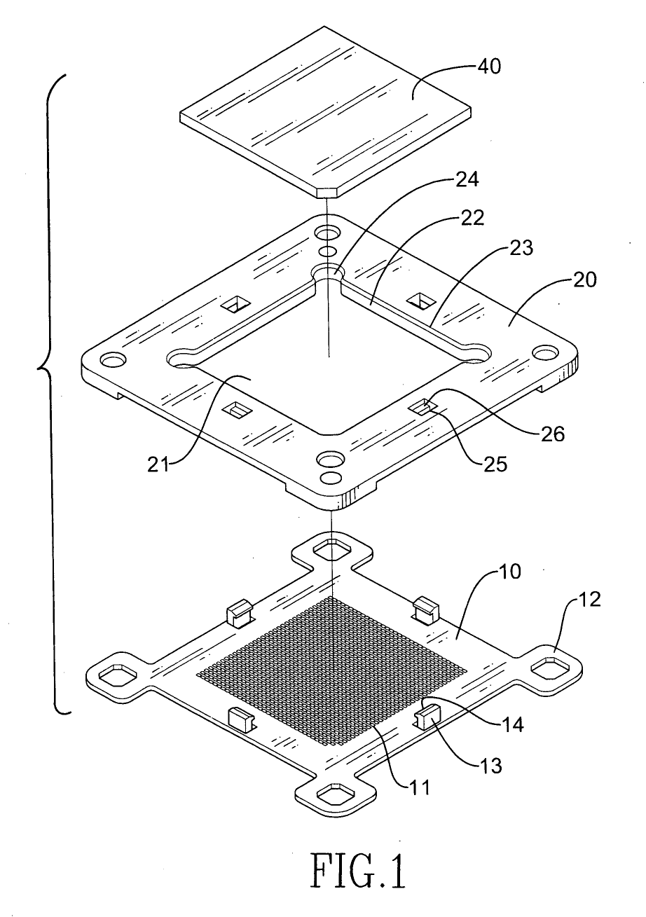

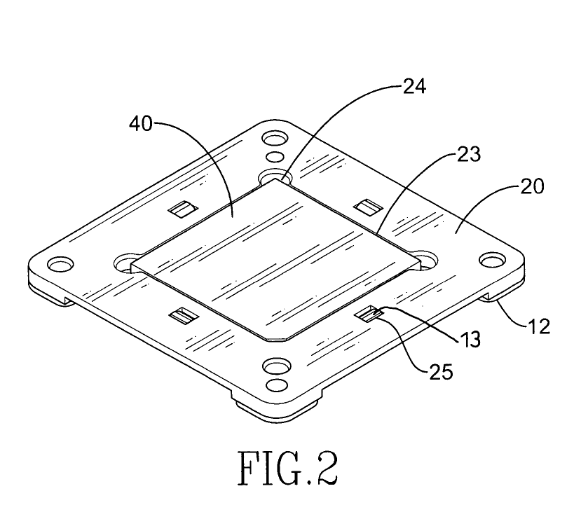

With reference to FIGS. 1-4, in a first embodiment, a socket for a CPU with L.G.A according to the present invention has a bottom plate (10) with four sides. Multiple apertures (11) are defined at a central portion of the bottom plate (10). Four ears (12) are respectively formed at four corners of the bottom plate (10), and four lugs (13) each with a barb (14) are respectively formed at the sides of the bottom plate (10).

The apertures (11) each have a metal strip (112) uprightly secured on an inner wall thereof by a fastener (111). The metal strip (112) has two deformable free ends (not numbered) respectively extending upwards and downwards out from the aperture (11). A supporting piece (113) is formed on the inner wall of the aperture (11) and opposite to the metal strip (112), and has inclined surfaces (not numbered) formed at upper and lower ends thereof. When the metal strip (112) is pressed, the free ends are elastically deformed to respectively abut the inclined surfaces of the supporting piece (113).

A frame (20) is mounted on the bottom plate (10) and has an opening (21) defined therein for receiving a CPU (40) and corresponding to the apertures (11). The opening (21) has a size slightly smaller than that of the CPU. Four edges (22), each with a slope (23) formed at a top thereof, are formed around the opening (21) for clamping the CPU, and four notches (24) are respectively formed at four corners of the edges (22). When the CPU (40) is pressed into the opening (21) along the slopes (23), the edges (22) will be deformed outwards to slightly expand the opening (21) for receiving and tightly clamping the CPU (40).

Four holes (25) are defined in the frame (20) around the opening (21) and respectively aligned with the lugs (13), and each have a step (26) formed therein. The lugs (13) are respectively inserted in the holes (25) and the barbs (14) are respectively attached to the steps (26).

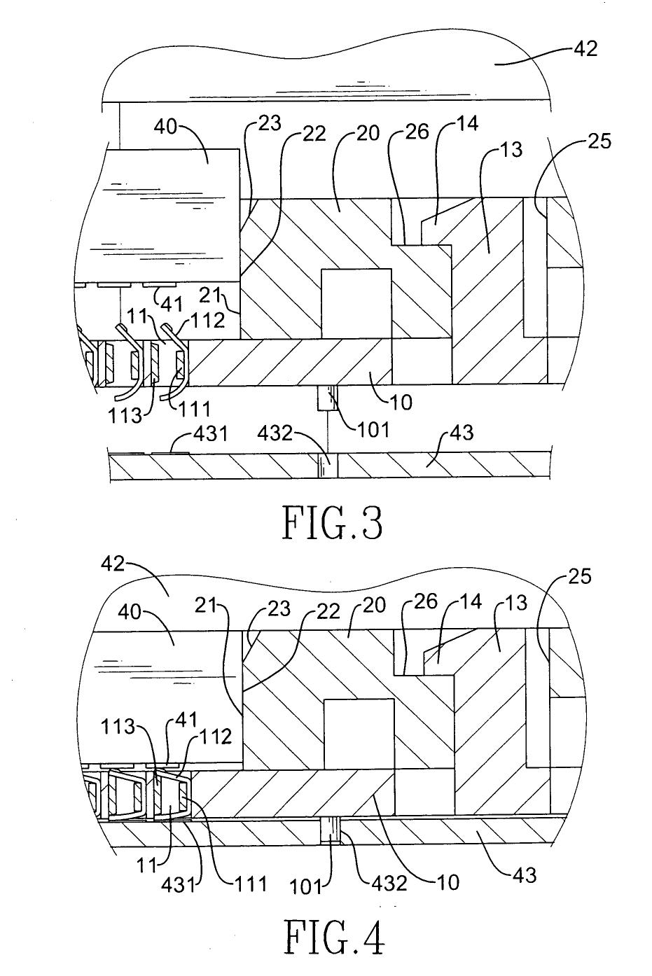

With reference to FIGS. 3 and 4, multiple poles (101) are formed at a bottom surface of the bottom plate (10) and corresponding to positioning holes (432) of a circuit board (mainboard) (43). In assembling, the frame (20) is secured on the bottom plate (10) by the lugs (13) respectively attached to the holes (25), and the bottom plate (10) is mounted on the circuit board (43) by the poles (101) respectively inserted in the positioning holes (432). The lower free ends of the metal strips (112) are deformed and electrically connected with nodes (431) of the circuit board (43).

The CPU (40) can be installed in the opening (21) of the frame (20), and a heat radiator (42) is mounted on the CPU (40). The metal strips (112) are pressed by L.G.A terminals (41) of the CPU (40), and the upper free ends of the strips (112) are deformed and electrically connected with the L.G.A terminals (41). Thus, the CPU (40) is electrically connected with the circuit board (43).

As illustrated in FIG. 4, because the L.G.A terminals (41) press the metal strip (112) only at the upper free ends, the metal strips (112) will not have elastic fatigue even after being used for a long time. Therefore, there is reliable electrical connection between the CPU and the circuit board.

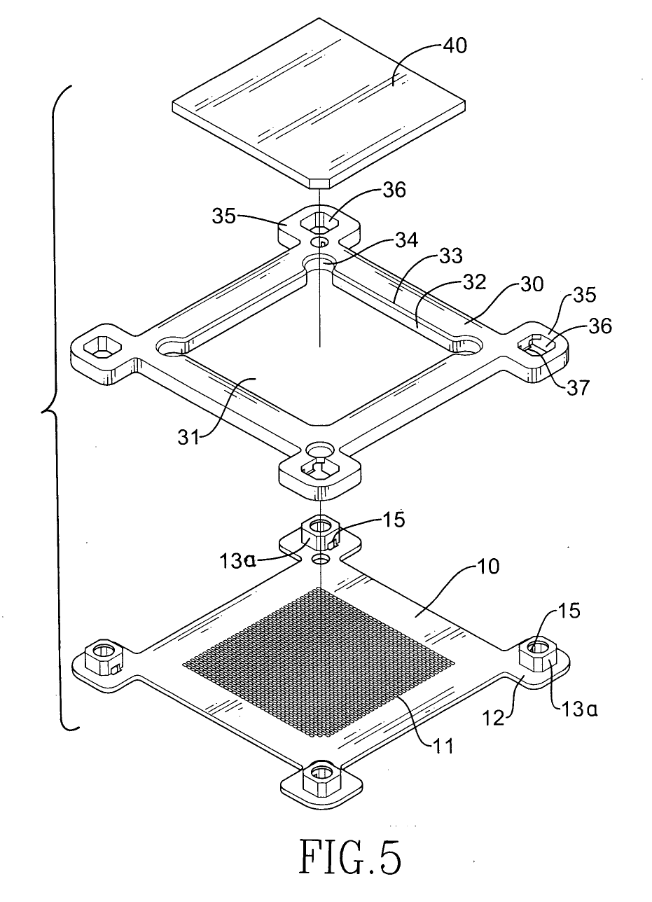

With reference to FIG. 5, in a second embodiment according to the present invention, the bottom plate (10a) has four first ears (12) formed at four corners thereof. Four hollow butts (13a) are respectively formed at the first ears (12) and each have a fastened part (15) formed therein. The frame (30) has four second ears (35) respectively formed at four corners thereof and in alignment with the first ears (12). Four holes (36) are respectively defined through the second ears (35), and each have a hook (37) formed in the holes (36). When the frame (30) is mounted on the bottom plate (10), the butts (13a) are respectively inserted in the holes (36) of the second ears (35) to attach the hooks (37) respectively to the fastened parts (15). Thus, the frame (30) is securely installed on the bottom plate (10a). The other structure and elements of the second embodiment are the same as those of the first embodiment as described above and have according numerals.

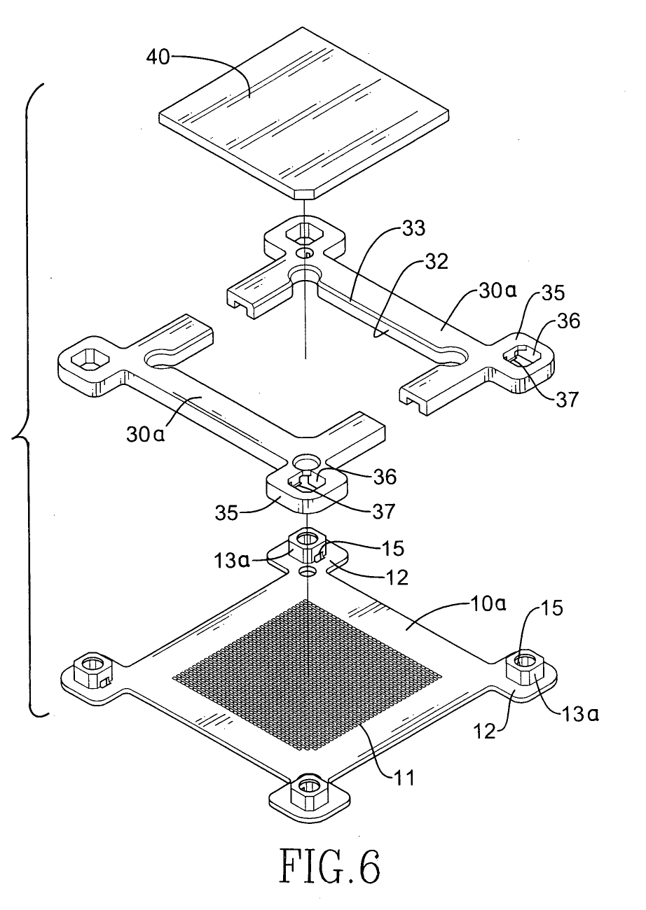

With reference to FIG. 6, in a third embodiment according to the present invention, the structure is the same as the second embodiment except for the frame (30a), being composed of two individual parts (not numbered), replacing the integral frame (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A socket for a CPU with L.G.A comprising:
a bottom plate (10) having multiple apertures (11) defined through the bottom plate, multiple metal strips (112) respectively secured in the apertures (11) by fasteners (11), each metal strip (112) having two deformable free ends extending upwards and downwards out from the respective aperture (11), and multiple supporting members (113) respectively formed on inner walls of the apertures (11) and opposite to the metal strip (112) for abutting the deformable free ends when the metal strips (112) are pressed; and
a frame (20) securely mounted on the bottom plate (10), the frame (20) having an opening (21) corresponding to the apertures (11), edges (22) formed around the opening (21) for clamping a CPU, and notches (24) defined at corners between the edges (22).

2. The socket as claimed in claim 1, wherein the bottom plate (10) has four sides, and four lugs (13) each with a barb (14) respectively formed at the four sides, and the frame (20) has four edges (22) corresponding to the four sides, and four holes (25) respectively defined through the edges (22) and aligned with the lugs (13), each hole (25) having a step (26) formed in the hole (25) for being attached by the barb (14).

3. The socket as claimed in claim 1, wherein the supporting member (113) has inclined surfaces formed at upper and lower ends of the supporting member (113) for abutting the deformable free ends when the metal strips (112) are pressed.

4. The socket as claimed in claim 1, wherein the bottom plate (10) has multiple poles (101) formed at a bottom surface of the bottom plate (10).

5. The socket as claimed in claim 1, wherein the bottom plate (10) has four sides, four first ears (12) respectively formed at four corners of the bottom plate (10), four hollow butts (13a) respectively formed on the first ears (12), and four fastened parts (15) respectively formed in the hollow butts (13a); and the frame (20) has four edges (22) corresponding to the four sides, four second ears (35) respectively formed at corners of the edges (22) corresponding to the first ears (12), four holes (36) respectively defined through the second ears (35) and four hooks (37) respectively formed in the holes (36) for attaching to the fastened parts (15) in the hollow parts (13a).

6. The socket as claimed in claim 1, wherein the edges (22) each have a slope (23) formed at a top of the edge (22).
